(19) United States
(12) Patent Application Publication
(10) Pub. No.: US 2023/0252568 A1
(43) Pub. Date: Aug. 10, 2023

(54) METHOD AND SYSTEM FOR ANOMALY DETECTION

(71) Applicant: JPMorgan Chase Bank, N.A., New York, NY (US)

(72) Inventors: Abhinav YADAV, Meerut (IN); Lucky GUPTA, New Delhi (IN); Navneet BAWEJA, East Meadow, NY (US); Daniel GOLKO, Canal Winchester, OH (US)

(73) Assignee: JPMorgan Chase Bank, N.A., New York, NY (US)

(21) Appl. No.: 17/654,143

(22) Filed: Mar. 9, 2022

(30) Foreign Application Priority Data
Jan. 25, 2022 (IN) 202211004129

(51) Int. Cl. G06Q 40/06

(52) U.S. Cl. CPC G06Q 40/06

(57) ABSTRACT

A method for providing anomaly detection to facilitate individual risk assessments is disclosed. The method includes compiling raw data from a data source, the raw data corresponding to a plurality of advisors; parsing the raw data to extract a data element; generating a structured data set based on the extracted data element; determining, by using a model, an anomaly value for each of the plurality of advisors, the anomaly value relating to a probability of an anomalous action; computing, by using the model, a risk score for each of the plurality of advisors based on the corresponding anomaly value; and generating a report for each of the plurality of advisors, the report including corresponding information that relates to the anomaly value and the risk score.

### CROSS REFERENCE TO RELATED APPLICATIONS

This application claims the benefit of Indian Provisional Patent Application No. 202211004129, filed Jan. 25, 2022, which is hereby incorporated by reference in its entirety.

### BACKGROUND

### 1. Field of the Disclosure

This technology generally relates to methods and systems for anomaly detection, and more particularly to methods and systems for providing anomaly detection by using machine learning models to facilitate risk assessments of an individual advisor.

### 2. Background Information

Many business entities offer financial services via a vast network of advisors. Often, the business entities are required by internal guidelines as well as external regulations to limit risks to client portfolios that are managed by the advisors. Historically, implementation of conventional detection techniques for identifying anomalous advisor actions has resulted in varying degrees of success with respect to effective mitigation of client risks.

One drawback of using the conventional techniques is that in many instances advisor metrics are determined at a high level for a group of advisors. As a result, identifying anomalous advisor actions for an individual advisor is resource intensive at best and not possible at worst. Additionally, due to the high-level advisor metrics, anomalous actions of an individual advisor may not be readily apparent until an adverse result affects the group of advisors.

Therefore, there is a need to provide anomaly detection to facilitate advisor risk assessments by using machine learning models to determine anomaly values and risk scores of an individual advisor.

### SUMMARY

The present disclosure, through one or more of its various aspects, embodiments, and/or specific features or sub-components, provides, inter alia, various systems, servers, devices, methods, media, programs, and platforms for providing anomaly detection by using machine learning models to facilitate risk assessments of an individual advisor.

According to an aspect of the present disclosure, a method for providing anomaly detection to facilitate individual risk assessments is disclosed. The method is implemented by at least one processor. The method may include compiling raw data from at least one data source, the raw data may correspond to a plurality of advisors; parsing the raw data to extract at least one data element; generating at least one structured data set based on the extracted at least one data element; determining, by using at least one model, at least one anomaly value for each of the plurality of advisors, the at least one anomaly value may relate to a probability of an anomalous action; computing, by using the at least one model, at least one risk score for each of the plurality of advisors based on the corresponding at least one anomaly value; and generating at least one report for each of the plurality of advisors, the at least one report may include corresponding information that relates to the at least one anomaly value and the at least one risk score.

In accordance with an exemplary embodiment, the raw data may include at least one from among alert data, profile data, and conduct report data, the raw data may relate to enterprise risk management information.

In accordance with an exemplary embodiment, the at least one data source may include at least one from among a first-party data source and a third-party data source, the at least one data source may correspond to at least one from among a real-time fraud prevention solution, a real-time anti-money laundering solution, and a real-time enterprise investigations solution.

In accordance with an exemplary embodiment, the method may further include determining, for each of the plurality of advisors, whether the at least one risk score is above a predetermined threshold; generating at least one notification when the at least one risk score is above the predetermined threshold, the at least one notification may include the corresponding at least one report; and transmitting the at least one notification to a responsible party.

In accordance with an exemplary embodiment, the method may further include generating at least one heat map when the at least one risk score is above the predetermined threshold, the at least one heat map may include risk score information for the plurality of advisors; and displaying, via a graphical user interface, the at least one heat map for the responsible party.

In accordance with an exemplary embodiment, to generate the at least one structured data set, the method may further include associating each of the at least one extracted data element with at least one category; identifying at least one factor for each of the at least one extracted data element; and assigning at least one risk classification for each of the at least one extracted data element based on the associated at least one category and the identified at least one factor.

In accordance with an exemplary embodiment, the at least one category may include at least one from among an advisor books category, a post trade alerts category, a conduct issues category, and a compliance findings category; and the at least one risk classification may include at least one from among a high-risk classification, a medium-risk classification, and a low-risk classification.

In accordance with an exemplary embodiment, to compute the at least one risk score for each of the plurality of advisors, the method may further include determining, by using the at least one model, at least one category risk score based on the at least one factor and the at least one risk classification, the at least one category risk score may correspond to each of the at least one category; determining, by using the at least one model, a composite category risk score based on the at least one category risk score; and computing, by using the at least one model, the at least one risk score for each of the plurality of advisors based on the at least one anomaly value and the composite category risk score.

In accordance with an exemplary embodiment, the at least one model may include at least one from among a machine learning model, a statistical model, a mathematical model, a process model, and a data model.

According to an aspect of the present disclosure, a computing device configured to implement an execution of a method for providing anomaly detection to facilitate individual risk assessments is disclosed. The computing device including a processor; a memory; and a communication interface coupled to each of the processor and the memory, wherein the processor may be configured to compile raw data from at least one data source, the raw data may correspond to a plurality of advisors; parse the raw data to extract at least one data element; generate at least one structured data set based on the extracted at least one data element; determine, by using at least one model, at least one anomaly value for each of the plurality of advisors, the at least one anomaly value may relate to a probability of an anomalous action; compute, by using the at least one model, at least one risk score for each of the plurality of advisors based on the corresponding at least one anomaly value; and generate at least one report for each of the plurality of advisors, the at least one report may include corresponding information that relates to the at least one anomaly value and the at least one risk score.

In accordance with an exemplary embodiment, the raw data may include at least one from among alert data, profile data, and conduct report data, the raw data may relate to enterprise risk management information.

In accordance with an exemplary embodiment, the at least one data source may include at least one from among a first-party data source and a third-party data source, the at least one data source may correspond to at least one from among a real-time fraud prevention solution, a real-time anti-money laundering solution, and a real-time enterprise investigations solution.

In accordance with an exemplary embodiment, the processor may be further configured to determine, for each of the plurality of advisors, whether the at least one risk score is above a predetermined threshold; generate at least one notification when the at least one risk score is above the predetermined threshold, the at least one notification may include the corresponding at least one report; and transmit the at least one notification to a responsible party.

In accordance with an exemplary embodiment, the processor may be further configured to generate at least one heat map when the at least one risk score is above the predetermined threshold, the at least one heat map may include risk score information for the plurality of advisors; and display, via a graphical user interface, the at least one heat map for the responsible party.

In accordance with an exemplary embodiment, to generate the at least one structured data set, the processor may be further configured to associate each of the at least one extracted data element with at least one category; identify at least one factor for each of the at least one extracted data element; and assign at least one risk classification for each of the at least one extracted data element based on the associated at least one category and the identified at least one factor.

In accordance with an exemplary embodiment, the at least one category may include at least one from among an advisor books category, a post trade alerts category, a conduct issues category, and a compliance findings category; and the at least one risk classification may include at least one from among a high-risk classification, a medium-risk classification, and a low-risk classification.

In accordance with an exemplary embodiment, to compute the at least one risk score for each of the plurality of advisors, the processor may be further configured to determine, by using the at least one model, at least one category risk score based on the at least one factor and the at least one risk classification, the at least one category risk score may correspond to each of the at least one category; determine, by using the at least one model, a composite category risk score based on the at least one category risk score; and compute, by using the at least one model, the at least one risk score for each of the plurality of advisors based on the at least one anomaly value and the composite category risk score.

In accordance with an exemplary embodiment, the at least one model may include at least one from among a machine learning model, a statistical model, a mathematical model, a process model, and a data model.

According to an aspect of the present disclosure, a non-transitory computer readable storage medium storing instructions for providing anomaly detection to facilitate individual risk assessments is disclosed. The storage medium including executable code which, when executed by a processor, may cause the processor to compile raw data from at least one data source, the raw data may correspond to a plurality of advisors; parse the raw data to extract at least one data element; generate at least one structured data set based on the extracted at least one data element; determine, by using at least one model, at least one anomaly value for each of the plurality of advisors, the at least one anomaly value may relate to a probability of an anomalous action; compute, by using the at least one model, at least one risk score for each of the plurality of advisors based on the corresponding at least one anomaly value; and generate at least one report for each of the plurality of advisors, the at least one report may include corresponding information that relates to the at least one anomaly value and the at least one risk score.

In accordance with an exemplary embodiment, the at least one model may include at least one from among a machine learning model, a statistical model, a mathematical model, a process model, and a data model.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing anomaly detection by using machine learning models to facilitate risk assessments of an individual advisor.

FIG. 4 is a flowchart of an exemplary process for implementing a method for providing anomaly detection by using machine learning models to facilitate risk assessments of an individual advisor.

FIG. 5 is an architecture diagram of an exemplary process for implementing a method for providing anomaly detection by using machine learning models to facilitate risk assessments of an individual advisor.

FIG. 6 is a methodology diagram of an exemplary machine learning process for implementing a method for providing anomaly detection by using machine learning models to facilitate risk assessments of an individual advisor.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

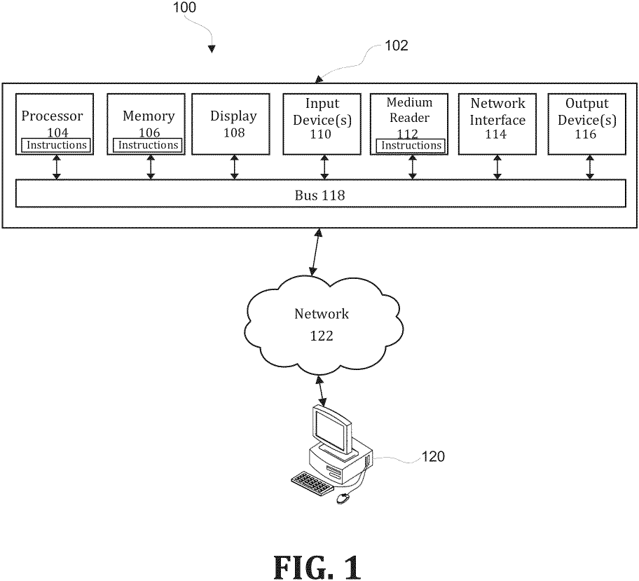

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing predictive anomaly detection by using machine learning models to facilitate risk assessments of an individual advisor.

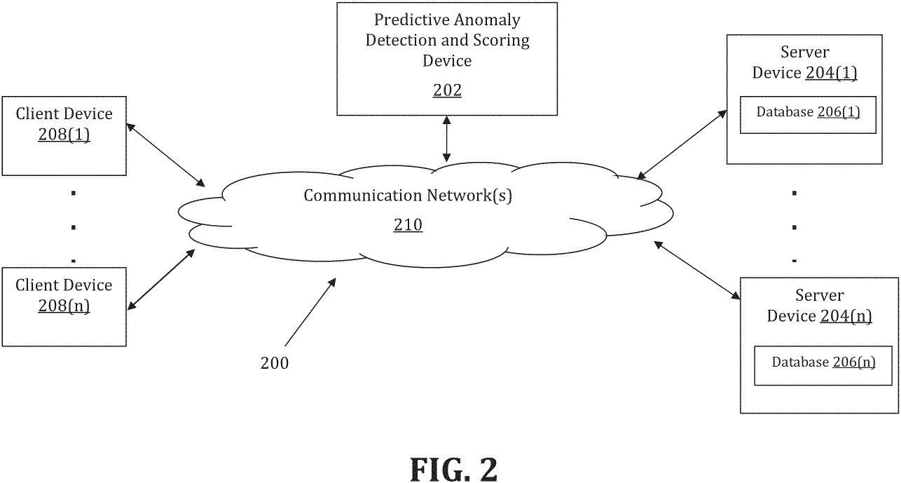

Referring to FIG. 2, a schematic of an exemplary network environment 200 for implementing a method for providing predictive anomaly detection by using machine learning models to facilitate risk assessments of an individual advisor is illustrated. In an exemplary embodiment, the method is executable on any networked computer platform, such as, for example, a personal computer (PC).

The method for providing predictive anomaly detection by using machine learning models to facilitate risk assessments of an individual advisor may be implemented by a Predictive Anomaly Detection and Scoring (PADS) device 202. The PADS device 202 may be the same or similar to the computer system 102 as described with respect to FIG. 1. The PADS device 202 may store one or more applications that can include executable instructions that, when executed by the PADS device 202, cause the PADS device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PADS device 202 itself, may be located in virtual server(s) running in a cloud-based computing environment rather than being tied to one or more specific physical network computing devices. Also, the application(s) may be running in one or more virtual machines (VMs) executing on the PADS device 202. Additionally, in one or more embodiments of this technology, virtual machine(s) running on the PADS device 202 may be managed or supervised by a hypervisor.

In the network environment 200 of FIG. 2, the PADS device 202 is coupled to a plurality of server devices 204(1)-204(n) that hosts a plurality of databases 206(1)-206(n), and also to a plurality of client devices 208(1)-208(n) via communication network(s) 210. A communication interface of the PADS device 202, such as the network interface 114 of the computer system 102 of FIG. 1, operatively couples and communicates between the PADS device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PADS device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and PADS devices that efficiently implement a method for providing predictive anomaly detection by using machine learning models to facilitate risk assessments of an individual advisor.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The PADS device 202 may be a standalone device or integrated with one or more other devices or apparatuses, such as one or more of the server devices 204(1)-204(n), for example. In one particular example, the PADS device 202 may include or be hosted by one of the server devices 204(1)-204(n), and other arrangements are also possible. Moreover, one or more of the devices of the PADS device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the PADS device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to raw data, data elements, structured data sets, anomaly values, risk scores, reports, advisor alert data, advisor profile data, and advisor conduct data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the PADS device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the PADS device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the PADS device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PADS device 202, the server devices 204(1)-204(n), or the client devices 208(1)-208(n), for example, may be configured to operate as virtual instances on the same physical machine. In other words, one or more of the PADS device 202, the server devices 204(1)-204(n), or the client devices 208(1)-208(n) may operate on the same physical device rather than as separate devices communicating through communication network(s) 210. Additionally, there may be more or fewer PADS devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

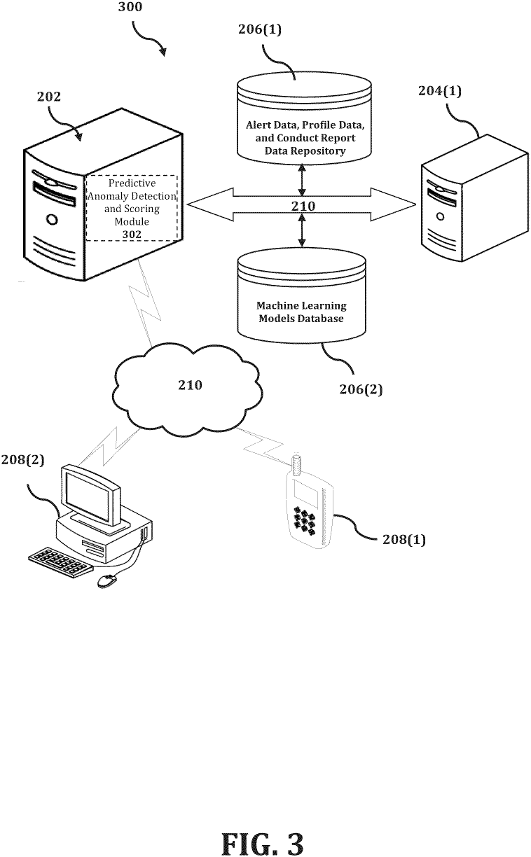

The PADS device 202 is described and shown in FIG. 3 as including a predictive anomaly detection and scoring module 302, although it may include other rules, policies, modules, databases, or applications, for example. As will be described below, the predictive anomaly detection and scoring module 302 is configured to implement a method for providing predictive anomaly detection by using machine learning models to facilitate risk assessments of an individual advisor.

An exemplary process 300 for implementing a mechanism for providing predictive anomaly detection by using machine learning models to facilitate risk assessments of an individual advisor by utilizing the network environment of FIG. 2 is shown as being executed in FIG. 3. Specifically, a first client device 208(1) and a second client device 208(2) are illustrated as being in communication with PADS device 202. In this regard, the first client device 208(1) and the second client device 208(2) may be “clients” of the PADS device 202 and are described herein as such. Nevertheless, it is to be known and understood that the first client device 208(1) and/or the second client device 208(2) need not necessarily be “clients” of the PADS device 202, or any entity described in association therewith herein. Any additional or alternative relationship may exist between either or both of the first client device 208(1) and the second client device 208(2) and the PADS device 202, or no relationship may exist.

Further, PADS device 202 is illustrated as being able to access an alert data, profile data, and conduct report data repository 206(1) and a machine learning models database 206(2). The predictive anomaly detection and scoring module 302 may be configured to access these databases for implementing a method for providing predictive anomaly detection by using machine learning models to facilitate risk assessments of an individual advisor.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the PADS device 202 via broadband or cellular communication. Of course, these embodiments are merely exemplary and are not limiting or exhaustive.

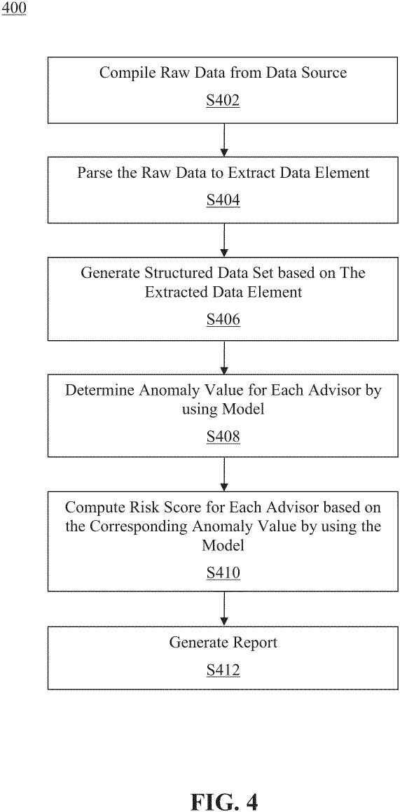

Upon being started, the predictive anomaly detection and scoring module 302 executes a process for providing predictive anomaly detection by using machine learning models to facilitate risk assessments of an individual advisor. An exemplary process for providing predictive anomaly detection by using machine learning models to facilitate risk assessments of an individual advisor is generally indicated at flowchart 400 in FIG. 4.

In the process 400 of FIG. 4, at step S402, raw data may be compiled from a data source. The raw data may correspond to a plurality of advisors. In an exemplary embodiment, the raw data may include at least one from among alert data, profile data, portfolio data, activities data, and conduct report data that corresponds to the plurality of advisors. The raw data may relate to enterprise risk management information for an advisor portfolio and advisor actions. The advisor portfolio information may include, for example, alert information, revenue information, and senior client information. The advisor actions information may include, for example, trade error information, surveillance information, and compliance information. In another exemplary embodiment, the data source may include at least one from among a first-party data source and a third-party data source. The data source may correspond to at least one from among a real-time fraud prevention solution, a real-time anti-money laundering solution, and a real-time enterprise investigations solution.

In another exemplary embodiment, the data source may include a component that performs supervisory functions and ensures proper sales practices for a financial institution. The component may monitor accounts, transactions, and sales representatives. The component may handle a broad range of sales practice issues and products such as, for example, account review, suitability analysis, registration, sales of mutual funds and annuities, as well as approval levels of options. In another exemplary embodiment, the data source may include an internally managed system for management reporting in the oversights and controls space. The internally managed system may house systematic data that is sources from factory systems and third-party products together with various file uploads from the business entity.

At step S404, the raw data may be parsed to extract data elements. The data elements may relate to an atomic unit of data that has precise meaning or precise semantics. In an exemplary embodiment, the data elements may correspond to textual characters such as, for example, alphabetic and numeric characters. The data elements may include a specific set of values or a range of values that corresponds to a logical definition of underlying data.

At step S406, a structured data set may be generated based on the extracted data element. The structured data set may correspond to a standardized format for providing the data elements to subsequent components for further processing. In an exemplary embodiment, generating the structured data set may include associating each of the extracted data elements with a category. The category may include at least one from among an advisor books category, a post trade alerts category, a conduct issues category, and a compliance findings category.

In another exemplary embodiment, a factor may also be identified for each of the extracted data elements. The factors may correspond to features that are identified based on business understanding of risky advisor actions and portfolio conditions. For anomaly detection machine learning models, all correlated features may be considered. Then, a risk classification may be assigned for each of the extracted data elements based on the associated category and the identified factor. The risk classification may include at least one from among a high-risk classification, a medium-risk classification, and a low-risk classification. In another exemplary embodiment, the risk classification may be usable to facilitate weighting of the factors. For example, a high-risk classification may result in a higher rating of a factor and a low-risk classification may result in a lower rating of a factor. As a result, the higher rating of the factor has a higher impact on overall risk scoring and the lower rating of the factor has a lower impact on overall risk scoring.

In another exemplary embodiment, preprocessing of the extracted data elements may be necessary prior to generation of the structured data set. The extracted data elements may be preprocessed to comply with data requirements of subsequent processing components, internal guidelines, as well as external regulations. In another exemplary embodiment, the extracted data elements may be preprocessed to comply with input data requirements of a machine learning model. For example, when a data point that is based on the extracted data elements has missing values, the data point may be replaced by a mean value that is representative of an entire population for that particular feature. In another example, the data point that is based on the extracted data elements may be scaled between a range by using a standard scaler library to improve efficiency of the machine learning model.

In another exemplary embodiment, the extracted data elements may be preprocessed to comply with internal guidelines relating to exposure of personally identifiable information. For example, internal guidelines may require specific treatments of personally identifiable information to preserve information security. As a result, the extracted data elements may be anonymized to satisfy the internal guidelines. In another exemplary embodiment, the extracted data elements may be preprocessed to satisfy external regulatory obligations. For example, governmental regulations may require specific treatments of client data to preserve information security. As a result, the extracted data elements may be preprocessed to satisfy the external regulatory obligations.

At step S408, an anomaly value may be determined for each of the plurality of advisors by using a model. The anomaly value may relate to a probability of an anomalous action. In an exemplary embodiment, the anomaly value may be usable to rate an individual advisor relative to the plurality of advisors. The anomaly value may represent the extent that the actions and portfolio of the individual advisor may correspond to an anomaly relative to the actions and portfolios of the plurality of advisors. In another exemplary embodiment, the anomaly value may represent the probability that an individual advisor is an anomaly when compared to the plurality of advisors. For example, in an isolation forest model, advisors with anomaly values that are outside of calculated norms may indicate high-risk portfolios and a propensity for high-risk activities.

In another exemplary embodiment, the model may include at least one from among a machine learning model, a statistical model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, 5-fold cross-validation analysis, balanced class weight analysis, etc. In another exemplary embodiment, machine learning analytical techniques may include unsupervised learning algorithms such as, for example, Apriori analysis, K-means clustering analysis, isolation forest analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model’s least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S410, a risk score may be computed for each of the plurality of advisors. The risk score may be computed based on the corresponding anomaly value by using the model. In an exemplary embodiment, computing the risk score for each of the plurality of advisors may include determining a category risk score based on the factor and the risk classification. The category risk score may be determined by using the model. The category risk score may correspond to each of the categories. For example, the category risk score may be calculated across each of the categories such as the advisor books category, the post trade alerts category, the conduct issues category, and the compliance findings category.

In another exemplary embodiment, a composite category risk score may be determined based on the category risk score. The composite category risk score may be determined by using the model. The composite category risk score may correspond to an aggregate of the category risk scores which provides an overall picture of advisor risk across the categories. Then, the risk score for each of the plurality of advisors may be computed by using the model. The risk score may be computed based on the anomaly value and the composite category risk score.

At step S412, a report for each of the plurality of advisors may be generated. The report may include corresponding information that relates to the anomaly value and the risk score. In an exemplary embodiment, the report may be associated with the corresponding advisor. The associated report may be persisted consistent with disclosures in the present application. In another exemplary embodiment, the report may include textual information as well as graphical elements. The graphical elements may relate to a representation of the anomaly value of a particular advisor relative to the plurality of advisors.

In another exemplary embodiment, whether the risk score is above a predetermined threshold may be determined for each of the plurality of advisors. The predetermined threshold may correspond to a business guideline that governs the reporting of anomalous advisor activities. For example, the predetermined threshold may indicate that a risk score above a number X requires further review by a supervisory component. In another exemplary embodiment, the predetermined threshold may be dynamically determined according to baseline data that is established from the plurality of advisors. For example, the predetermined threshold may be dynamically adjusted because a baseline average of risk scores for the plurality of advisors fluctuates based on market conditions.

In another exemplary embodiment, a notification may be automatically generated when the risk score is above the predetermined threshold. The notification may include the corresponding report. For example, when the disclosed system determines that the risk score for advisor A is above the predetermined threshold, the disclosed system may automatically generate the notification. In another exemplary embodiment, a responsible party may be determined based on associations with the corresponding advisor. The responsible party may include a supervisor of the advisor as well as a compliance component that is tasked with risk mitigation. Then, the notification may be transmitted to the responsible party.

In another exemplary embodiment, a heat map may be generated when the risk score is above the predetermined threshold. The heat map may correspond to a graphical representation of data in which values are represented by colors to indicate a relative magnitude. The graphical representation may provide a visual summary of the risk score and the anomaly values. The heat map may include risk score information for the plurality of advisors. In another exemplary embodiment, the heat map may be displayed for the responsible party via a graphical user interface such as, for example, a dashboard. The graphical user interface may include graphical elements that enables user interaction and input.

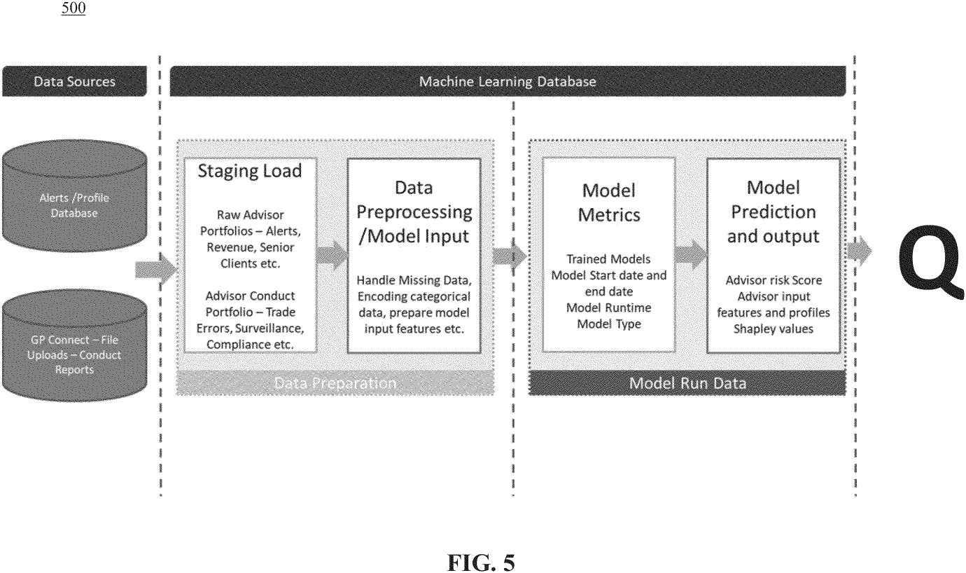

FIG. 5 is an architecture diagram 500 of an exemplary process for implementing a method for providing anomaly detection by using machine learning models to facilitate risk assessments of an individual advisor. In FIG. 5, a machine learning based anomaly detection model may be utilized to rate each advisor with an anomaly value and a risk score. A higher score may denote a greater risk is present in the portfolio, and a lower score will mark the normal and ideal behavior of the portfolio.

As illustrated in FIG. 5, raw data may be compiled from various sources consistent with disclosures in the present application. The raw data may include alert data, profile data, uploaded data, and conduct report data. The raw data may then pass to a data preparation component. The data preparation component may include a staging load component and a data preprocessing/model input component. The staging load component may correspond to an intermediate storage area that facilitates data processing during the extract, transform and load process. The staging load component may store advisor portfolio data such as, for example, alert data, revenue data, and senior client data as well as store advisor conduct data such as, for example, trade error data, surveillance data, and compliance data. The data preprocessing/model input component may prepare the data for model input. For example, the preprocessing/model input component may handle missing data, encode categorical data, and prepare model input features.

After the data has been prepared by the data preparation component, the data may be associated with model metrics. The model metrics may include information that relates to a corresponding trained model, a model start date and end date, a model runtime, and a model type. Then, the data may be inputted into a model prediction and output component. The model prediction and output component may determine advisor risk scores, advisor input features and profiles, as well as shapely values consistent with disclosures in the present application. A resulting output may be available for presentation and/or further processing by downstream components.

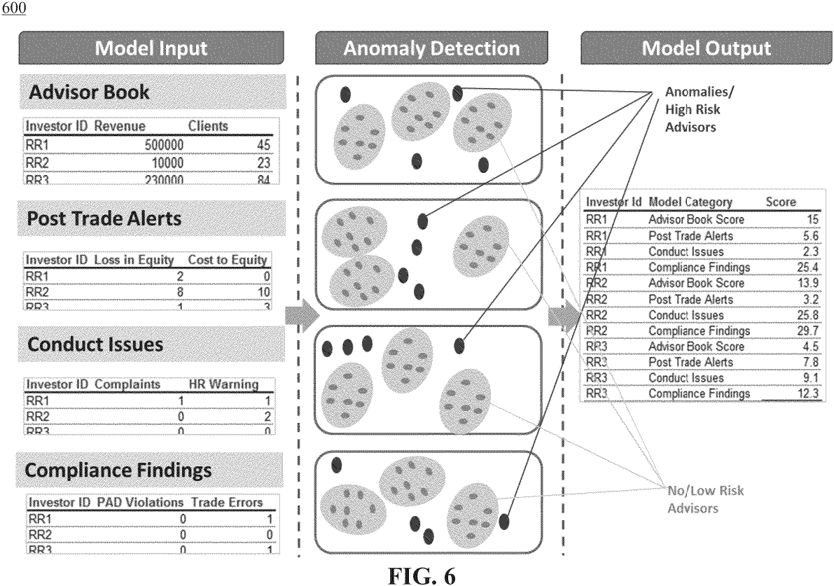

FIG. 6 is a methodology diagram 600 of an exemplary machine learning process for implementing a method for providing anomaly detection by using machine learning models to facilitate risk assessments of an individual advisor. In FIG. 6, a modeling technique such as, for example, an isolation forest modeling technique may be implemented to identify advisor anomalies.

As illustrated in FIG. 6, model input may incorporate categorized data consistent with disclosures in the present application. The categories may include an advisor books category, a post trade alerts category, a conduct issues category, and a compliance findings category. Then, the machine learning model is utilized consistent with disclosures in the present application to identify anomalies associated with high-risk advisors and baseline activities associated with low-risk advisors. The machine learning model may output risk scores for each of a plurality of advisors according to factors that impact the categories. Consistent with disclosures in the present application, the outputted risk scores may be combined into a composite risk score to provide an overall risk assessment.

Accordingly, with this technology, an optimized process for providing predictive anomaly detection by using machine learning models to facilitate risk assessments of an individual advisor is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing anomaly detection to facilitate individual risk assessments, the method being implemented by at least one processor, the method comprising:
compiling, by the at least one processor, raw data from at least one data source, the raw data corresponding to a plurality of advisors;
parsing, by the at least one processor, the raw data to extract at least one data element;
generating, by the at least one processor, at least one structured data set based on the extracted at least one data element;
determining, by the at least one processor using at least one model, at least one anomaly value for each of the plurality of advisors, the at least one anomaly value relating to a probability of an anomalous action;
computing, by the at least one processor using the at least one model, at least one risk score for each of the plurality of advisors based on the corresponding at least one anomaly value; and
generating, by the at least one processor, at least one report for each of the plurality of advisors, the at least one report including corresponding information that relates to the at least one anomaly value and the at least one risk score.

2. The method of claim 1, wherein the raw data includes at least one from among alert data, profile data, and conduct report data, the raw data relating to enterprise risk management information.

3. The method of claim 1, wherein the at least one data source includes at least one from among a first-party data source and a third-party data source, the at least one data source corresponding to at least one from among a real-time fraud prevention solution, a real-time anti-money laundering solution, and a real-time enterprise investigations solution.

4. The method of claim 1, further comprising:
determining, by the at least one processor for each of the plurality of advisors, whether the at least one risk score is above a predetermined threshold;
generating, by the at least one processor, at least one notification when the at least one risk score is above the predetermined threshold, the at least one notification including the corresponding at least one report; and
transmitting, by the at least one processor, the at least one notification to a responsible party.

5. The method of claim 4, further comprising:
generating, by the at least one processor, at least one heat map when the at least one risk score is above the predetermined threshold, the at least one heat map including risk score information for the plurality of advisors; and
displaying, by the at least one processor via a graphical user interface, the at least one heat map for the responsible party.

6. The method of claim 1, wherein generating the at least one structured data set further comprises:
associating, by the at least one processor, each of the at least one extracted data element with at least one category;
identifying, by the at least one processor, at least one factor for each of the at least one extracted data element; and
assigning, by the at least one processor, at least one risk classification for each of the at least one extracted data element based on the associated at least one category and the identified at least one factor.

7. The method of claim 6, wherein the at least one category includes at least one from among an advisor books category, a post trade alerts category, a conduct issues category, and a compliance findings category; and wherein the at least one risk classification includes at least one from among a high-risk classification, a medium-risk classification, and a low-risk classification.

8. The method of claim 6, wherein computing the at least one risk score for each of the plurality of advisors further comprises:
determining, by the at least one processor using the at least one model, at least one category risk score based on the at least one factor and the at least one risk classification, the at least one category risk score corresponding to each of the at least one category;
determining, by the at least one processor using the at least one model, a composite category risk score based on the at least one category risk score; and
computing, by the at least one processor using the at least one model, the at least one risk score for each of the plurality of advisors based on the at least one anomaly value and the composite category risk score.

9. The method of claim 1, wherein the at least one model includes at least one from among a machine learning model, a statistical model, a mathematical model, a process model, and a data model.

10. A computing device configured to implement an execution of a method for providing anomaly detection to facilitate individual risk assessments, the computing device comprising:
a processor;
a memory; and
a communication interface coupled to each of the processor and the memory,
wherein the processor is configured to:
compile raw data from at least one data source, the raw data corresponding to a plurality of advisors;
parse the raw data to extract at least one data element;
generate at least one structured data set based on the extracted at least one data element;
determine, by using at least one model, at least one anomaly value for each of the plurality of advisors, the at least one anomaly value relating to a probability of an anomalous action;
compute, by using the at least one model, at least one risk score for each of the plurality of advisors based on the corresponding at least one anomaly value; and
generate at least one report for each of the plurality of advisors, the at least one report including corresponding information that relates to the at least one anomaly value and the at least one risk score.

11. The computing device of claim 10, wherein the raw data includes at least one from among alert data, profile data, and conduct report data, the raw data relating to enterprise risk management information.

12. The computing device of claim 10, wherein the at least one data source includes at least one from among a first-party data source and a third-party data source, the at least one data source corresponding to at least one from among a real-time fraud prevention solution, a real-time anti-money laundering solution, and a real-time enterprise investigations solution.

13. The computing device of claim 10, wherein the processor is further configured to:
determine, for each of the plurality of advisors, whether the at least one risk score is above a predetermined threshold;
generate at least one notification when the at least one risk score is above the predetermined threshold, the at least one notification including the corresponding at least one report; and
transmit the at least one notification to a responsible party.

14. The computing device of claim 13, wherein the processor is further configured to:
generate at least one heat map when the at least one risk score is above the predetermined threshold, the at least one heat map including risk score information for the plurality of advisors; and
display, via a graphical user interface, the at least one heat map for the responsible party.

15. The computing device of claim 10, wherein, to generate the at least one structured data set, the processor is further configured to:
associate each of the at least one extracted data element with at least one category;
identify at least one factor for each of the at least one extracted data element; and
assign at least one risk classification for each of the at least one extracted data element based on the associated at least one category and the identified at least one factor.

16. The computing device of claim 15, wherein the at least one category includes at least one from among an advisor books category, a post trade alerts category, a conduct issues category, and a compliance findings category; and wherein the at least one risk classification includes at least one from among a high-risk classification, a medium-risk classification, and a low-risk classification.

17. The computing device of claim 15, wherein, to compute the at least one risk score for each of the plurality of advisors, the processor is further configured to:
determine, by using the at least one model, at least one category risk score based on the at least one factor and the at least one risk classification, the at least one category risk score corresponding to each of the at least one category;
determine, by using the at least one model, a composite category risk score based on the at least one category risk score; and
compute, by using the at least one model, the at least one risk score for each of the plurality of advisors based on the at least one anomaly value and the composite category risk score.

18. The computing device of claim 10, wherein the at least one model includes at least one from among a machine learning model, a statistical model, a mathematical model, a process model, and a data model.

19. A non-transitory computer readable storage medium storing instructions for providing anomaly detection to facilitate individual risk assessments, the storage medium comprising executable code which, when executed by a processor, causes the processor to:
compile raw data from at least one data source, the raw data corresponding to a plurality of advisors;
parse the raw data to extract at least one data element;
generate at least one structured data set based on the extracted at least one data element;
determine, by using at least one model, at least one anomaly value for each of the plurality of advisors, the at least one anomaly value relating to a probability of an anomalous action;
compute, by using the at least one model, at least one risk score for each of the plurality of advisors based on the corresponding at least one anomaly value; and
generate at least one report for each of the plurality of advisors, the at least one report including corresponding information that relates to the at least one anomaly value and the at least one risk score.

20. The storage medium of claim 19, wherein the at least one model includes at least one from among a machine learning model, a statistical model, a mathematical model, a process model, and a data model.
